(19) United States
(12) Patent Application Publication
(10) Pub. No.: US 2025/0259803 A1
(43) Pub. Date: Aug. 14, 2025

(54) SYSTEMS AND METHODS TO MANUFACTURE A WAVE-SHAPED CAPACITOR

(71) Applicant: VQ RESEARCH, INC., Palo Alto, CA (US)

(72) Inventor: John Gustafson, Santa Clara, CA (US)

(21) Appl. No.: 19/048,872

(22) Filed: Feb. 8, 2025

Related U.S. Application Data
(60) Provisional application No. 63/551,558, filed on Feb. 9, 2024.

(51) Int. Cl. H01G 13/00; H01G 4/012; H01G 4/30

(52) U.S. Cl. CPC H01G 13/00; H01G 4/012; H01G 4/30

(57) ABSTRACT

Systems and methods for press-forming a flexible thin sheet of ceramic paste, such as, e.g., barium titanate, into a wavy shape. The wave may be 1-dimensional, such as, e.g., a sinusoid, or 2-dimensional, such as, e.g., an egg-crate shape. A mold embossed with a reverse, or negative, of an intended form of the wavy shape may be used. The egg-crate shape ceramic layers may be stacked with alternating sheets of a conductive, or electrode, material before being sintered and densified. Alternatively, the ceramic sheets can be layered with the sheets of conductive material, and then pressed into the wavy shape together. Optionally, conductive ink may be applied to the ceramic sheets instead of using sheets of conductive material in both cases.

### CLAIMS OF PRIORITY

This patent application claims priority from:
(1) U.S. provisional patent application No. 63/551,558, entitled ‘Surface area optimization of multilayer ceramic capacitors’, filed Feb. 9, 2024.

The application is incorporated by reference herein in its entirety.

This disclosure relates generally to modifying a process of producing multilayer ceramic capacitors to achieve a wavy shape.

### BACKGROUND

Multilayer ceramic capacitors (MLCCs) are essential components in modern electronic devices, providing energy storage and filtering capabilities. The demand for MLCCs has surged due to the miniaturization of electronic circuits and the increasing need for high-capacitance, low-profile components. Traditional production methods for MLCCs involve stacking and sintering multiple layers of ceramic materials, and typically include the preparation of ceramic powders, the formation of green sheets, and the assembly of these sheets into multilayer structures. These structures are then subjected to high-temperature sintering to achieve the desired electrical properties.

Innovations in the production process are necessary to enhance the efficiency, yield, and quality of MLCCs. This includes advancements in material formulations, improved techniques for layer alignment and stacking, and optimized sintering profiles. The development of new methods that address these challenges can lead to the production of MLCCs with superior electrical characteristics, increased reliability, and reduced manufacturing costs.

### SUMMARY

Systems and methods for press-forming a flexible thin sheet of ceramic paste, such as, e.g., barium titanate, into a wavy shape. The wave may be 1-dimensional, such as, e.g., a sinusoid, or 2-dimensional, such as, e.g., an egg-crate shape. A mold embossed with a reverse, or negative, of an intended form of the wavy shape may be used. The egg-crate shape ceramic layers may be stacked with alternating sheets of a conductive, or electrode, material before being sintered and densified. Alternatively, the ceramic sheets can be layered with the sheets of conductive material, and then pressed into the wavy shape together. Optionally, conductive ink may be applied to the ceramic sheets instead of using sheets of conductive material in both cases.

The capacitance of a wavy-shaped capacitor increases with the amplitude of the wave, which can be expressed with the formula z=A·(sin(x)+sin(y)), where A equals the wave's amplitude. Other functions can be used to create the wavy shape, for example to increase the curvature at the extremes of the wave.

### BRIEF DESCRIPTION OF THE DRAWINGS

Figures are illustrated by way of example and are not limited to the accompanying drawings, in which, like references indicate similar elements.

FIG. 1 is a schematic overview showing an MLCC production process known as “tape casting”.

FIG. 2 is a schematic overview showing a modified tape casting process, highlighting inventive concepts of the present disclosure.

FIGS. 3A-3B are graphical representations of molds used in the production of wavy-shaped ceramic capacitors.

FIG. 4 is a schematic diagram of a cross-section view of an example plate capacitor.

FIG. 5 is a perspective view of an example single-capacitive layer capacitor, shown semi-transparent for clarity.

FIG. 6 shows a single capacitive layer capacitor encased in insulation, and capped with conductive electrodes.

FIGS. 7A-7B show cutaway perspective views of a multilayer ceramic capacitor with wavy-shaped conductive layers.

FIG. 8A is a front cross-section of multilayer ceramic capacitor modified into a wavy shape. FIG. 8B shows alternating upward end and downward end of non-connecting conductive layers of an MLCC.

FIG. 9 illustrates a multilayer ceramic capacitor comprising wave-like structures aligned parallel to both of the capacitor's width and length.

FIG. 10 is a perspective view of a conductive layer comprising an egg-crate shape.

FIG. 11 is a schematic representation of a plate capacitor modified into a wave-like shape.

FIG. 12 illustrates a cross-section of a multilayer ceramic capacitor with rounded dielectric layer edges.

FIG. 13A-13B is a flowchart of a method for forming a wavy shape MLCC.

### DETAILED DESCRIPTION

Although the present has been described with reference to specific examples, it will be evident that various modifications and changes may be made without departing from their spirit and scope. The modifications and variations include any relevant combination of the disclosed features. Equivalent elements, materials, processes or steps may be substituted for those representatively illustrated and described herein. Certain structures and features may be utilized independently of the use of other structures and features. In addition, the components shown in the figures, their connections, couplings, relationships, and their functions, are meant to be exemplary only, and are not meant to limit the examples described herein.

Systems and methods for press-forming a flexible thin sheet of ceramic paste, such as, e.g., barium titanate, into a wavy shape. The wave may be 1-dimensional, such as, e.g., a sinusoid, or 2-dimensional, such as, e.g., an egg-crate shape. A mold embossed with a reverse, or negative, of an intended form of the wavy shape may be used. The egg-crate shape ceramic layers may be stacked with alternating sheets of a conductive, or electrode, material before being sintered and densified. Alternatively, the ceramic sheets can be layered with the sheets of conductive material, and then pressed into the wavy shape together. Optionally, conductive ink may be applied to the ceramic sheets instead of using sheets of conductive material in both cases.

The capacitance of a wavy-shaped capacitor increases with the amplitude of the wave, which can be expressed with the formula z=A·(sin(x)+sin(y)), where A equals the wave's amplitude. Other functions can be used to create the wavy shape, for example to increase the curvature at the extremes of the wave.

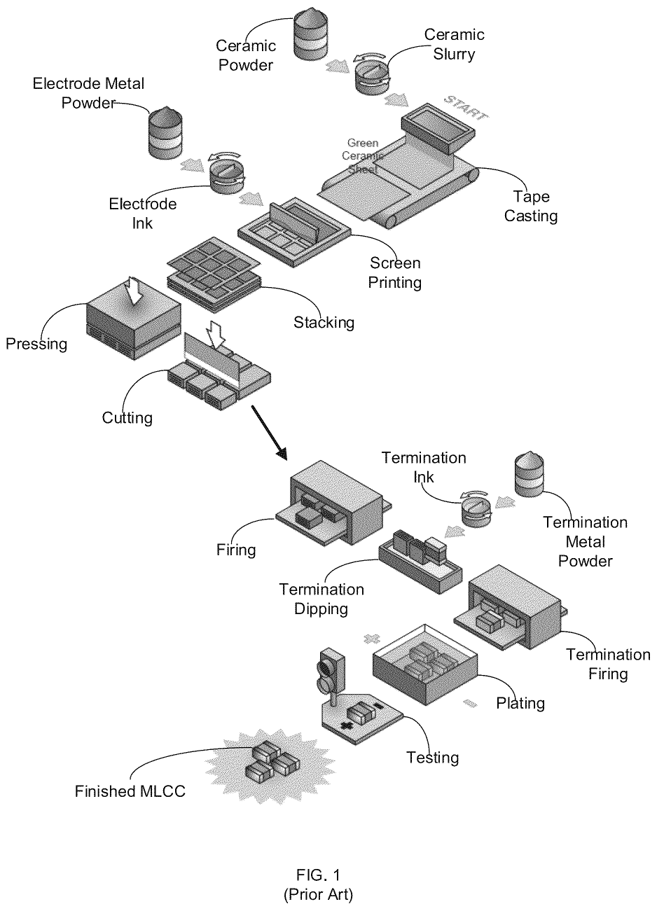

FIG. 1 is a schematic overview showing an MLCC production process known as “tape casting”. The process of making ceramic capacitors may involve additional, reduced, and/or modified steps, though the general idea is the same. Foremost, ceramic powder may be mixed with binders, plasticizers, dispersants, and solvents to create a ceramic slurry, which allows easy processing of the material. The slurry may be poured onto a conveyor belt inside a drying oven, resulting in a dry ceramic tape. Alternatively, it may be poured onto a moving carrier film, such as, e.g., a polymer sheet, and spread into a thin, uniform layer using a doctor blade. The tape may then be cut into smaller pieces called sheets. The thickness of each sheet may determine voltage and capacitance ratings of the capacitor.

Electrode ink may be made from a metal powder that is mixed with solvents. The electrodes may then be printed onto the ceramic sheets using a screen printing process. Afterwards, the sheets may be stacked to create a multilayer structure. Pressure and heat may be applied to the stack to fuse the separate layers, which may create a monolithic structure called a “bar”. The bar may be cut into the separate capacitors. The parts are now in what is called a “green state”. Generally, the smaller the size, the more parts there are in a bar. The parts may be fired in kilns with slow moving conveyor belts. The temperature profile may be very important to the characteristics of the capacitors. They also may be fired in a single kiln with a programmed timing for its temperature; the single kiln saves floor space, but the conveyer belt approach saves energy since regions of the kiln are brought to the necessary temperature and held constant.

A termination may provide the first layer of electrical and mechanical connection to the capacitor. Metal powder may be mixed with liquids to create the termination ink. Each terminal of the capacitor may then be dipped in the ink and the parts may be fired in kilns. The parts may also be tested and sorted to their correct capacitance tolerances. At this point the capacitor manufacturing may be complete. The parts may be packaged on tape and reel, or shipped in bulk.

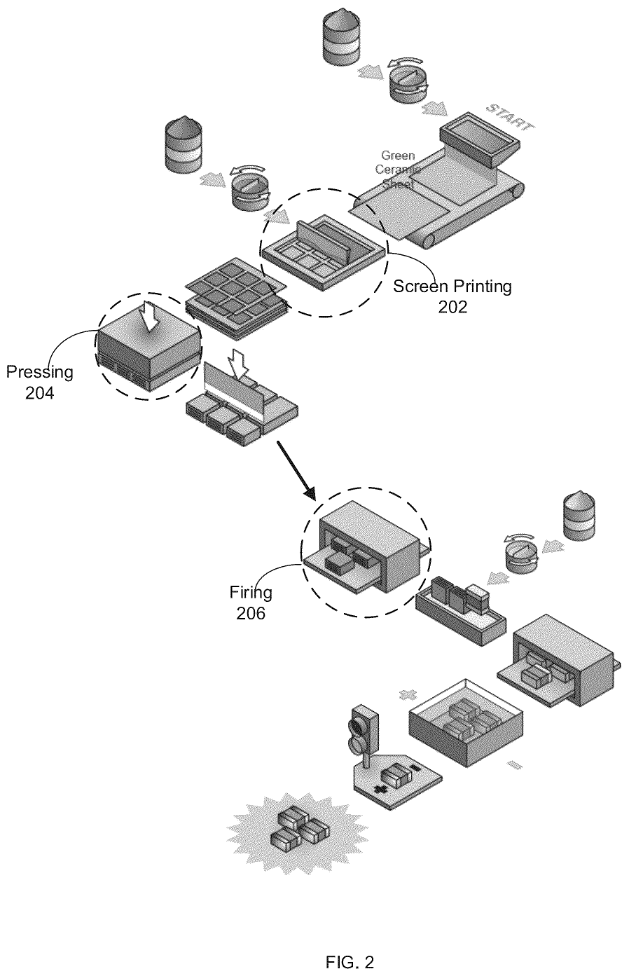

FIG. 2 is a schematic overview showing a modified tape casting process, highlighting inventive concepts of the present disclosure. The process of making ceramic capacitors may involve additional, reduced, and/or modified steps, though the general idea is the same. Foremost, ceramic powder may be mixed with binders, plasticizers, dispersants, and solvents to create a ceramic slurry, which allows easy processing of the material. The slurry may be poured onto a conveyor belt inside a drying oven, resulting in a dry ceramic tape. Alternatively, it may be poured onto a moving carrier film, such as, e.g., a polymer sheet, and spread into a thin, uniform layer using a doctor blade. The tape may then be cut into smaller pieces called sheets. The thickness of each sheet may determine voltage and capacitance ratings of the capacitor.

During screen printing 202, electrode ink may be made from a metal powder that is mixed with solvents, and then printed onto the ceramic sheets. The electrodes may then be printed onto the ceramic sheets using a screen printing process. Afterwards, the sheets may be stacked to create a multilayer structure. On the other hand, layers of conductive material may be stacked alternatively with the ceramic layers, instead of being printed directly onto the ceramic layers. The electrodes may be attached to the conductive layers to create an interleaved comb. The interleaving equates to more area and less separation between layers than a simple plate capacitor, both of which increase capacitance. In some cases, the sheets may be folded to create the multilayer structure.

Pressuring 204 applies pressure and heat may be applied to the stack or fold to fuse the separate layers, which may create a monolithic structure called a “bar”. A mold embossed with a reverse, or negative, of an intended form of the wavy shape may be used to press-form the bar. The wave shape may be 1-dimensional, such as, e.g., a sinusoid, or 2-dimensional, such as, e.g., an egg-crate shape. The bar may be cut into the separate capacitors. The parts are now in what is called a “green state”. Generally, the smaller the size, the more parts there are in a bar.

Firing 206 sinters the green part within an oven which may comprise slow moving conveyor belts. Sintering may require temperatures in the 1200-1400° C. range, so a polymer mold will not survive the heat. To address this problem, three separate approaches are presented herein. Any method may be used.

In a “sacrificial” approach, the mold is created using ordinary plastics, such as those seen in low-cost 3D printers may disappear through pyrolysis as the kiln temperature increases. At the same time, the liquid in the green part may vaporize, leaving the layers rigid so they retain the wavy shape. A disadvantage to this method is that it destroys the mold and a new mold is required for every wavy capacitor, but this may be outweighed by the increase in value of the resulting capacitor. Another disadvantage is that the pyrolysis creates fumes as the plastic chars and eventually disappears, so those fumes must be properly vented and prevented from going into the atmosphere.

In a “one-stage reusable” method, the mold may be made of high-temperature ceramics that can withstand 1400° C. or more, with no degradation. Some, like the ones used as heat shields on the International Space Shuttle, can even go above 2000° C. Since these ceramic materials are not ferroelectric like barium titanate, they thus may be amenable to ceramic 3D printing techniques. In using them to shape the green part, each mold may be coated with a thin layer of material, such as, e.g., silicone oil, to prevent the green part from fusing with the ceramic mold, creating some fumes from pyrolysis/boiling but less than the sacrificial method. Another way to prevent fusion is to apply a thin layer of dust made of the high-temperature ceramic, analogous to applying flour to a rolling pin when making pastries. Then, there would be no fumes produced.

In a “two-stage reusable”, Teflon (polytetrafluoroethylene, or PTFE), which is 3D-printable by low-cost extrusion printers, is used to create the mold. It has a melting point of 327° C. If the molds are 3D printed in Teflon, the green part could be raised to lower temperatures (120-150° C.) and held at that temperature until its liquid component is gone and the part is rigid, i.e., cured. To prevent the green part from being brittle and weak, the ceramic slurry at the initial stages of the process may comprise a curing or thermosetting type of binder, such as, e.g., phenolformaldahyde, which may lower the setting temperature to well below 300° C. The additive system may be a solvent type.

After the initial firing process, the resulting intermediate part and its molds can then be cooled to room temperature. The molds will easily be removable from the green part since Teflon is a non-stick material. The now-rigid, intermediate green part can then be put back into a kiln and run through its usual high-temperature sintering process.

A termination may provide the first layer of electrical and mechanical connection to the capacitor. Metal powder may be mixed with liquids to create the termination ink. Each terminal of the capacitor may then be dipped in the ink and the parts may be fired in kilns. The parts may also be tested and sorted to their correct capacitance tolerances. At this point the capacitor manufacturing may be complete. The parts may be packaged on tape and reel, or shipped in bulk.

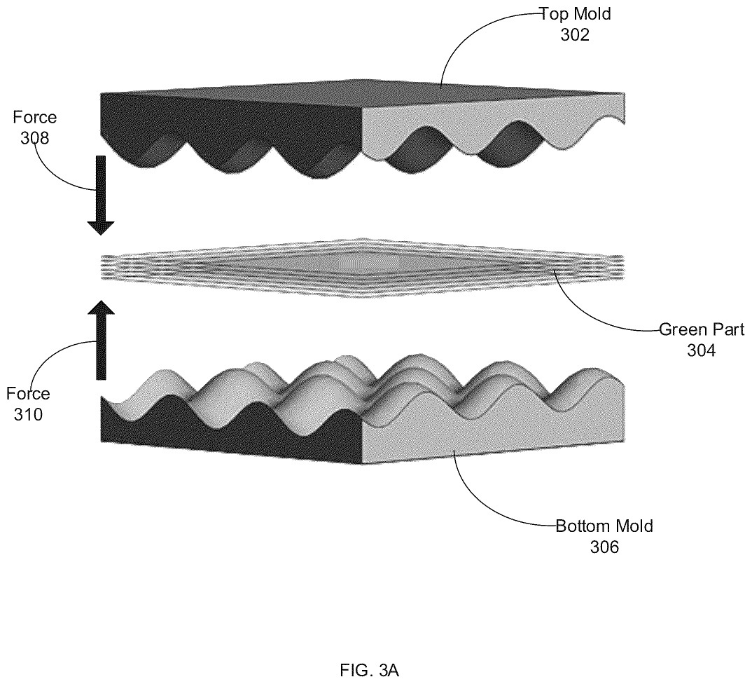

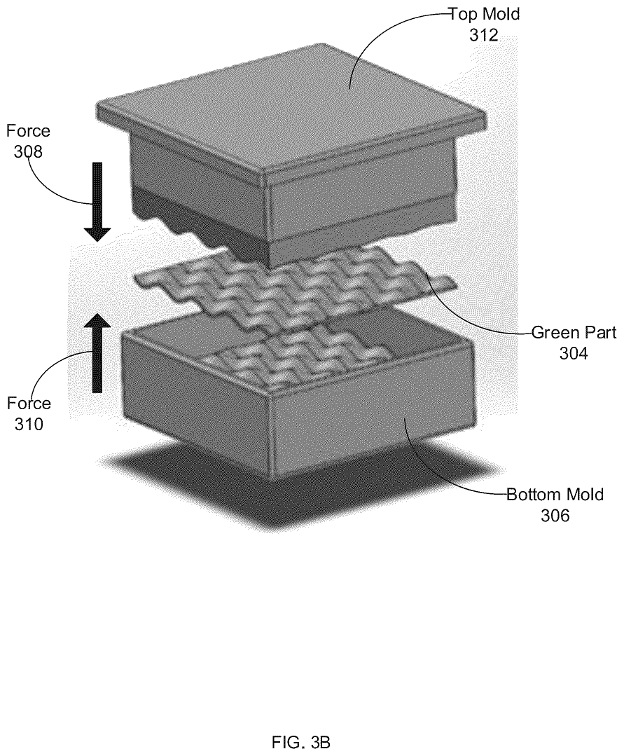

FIGS. 3A-3B are graphical representations of molds used in the production of wavy-shaped ceramic capacitors. The molds may be embossed with a reverse, or negative, of an intended form of the wavy shape on a top portion and a bottom portion; the molds may be flat on the non-wavy side, which will make it easier to apply even pressure to the green part. The wavy shape may be 1-dimensional, such as, e.g., a sinusoid, or 2-dimensional, such as, e.g., an egg-crate shape. In FIG. 3A, a cutaway portion of plurality of repeating molds is shown. The mold may comprise top mold 302 positioned above green part 304, and bottom mold 306 positioned below green part 304. Green part 304 may comprise alternating layers of ceramic and conductive layers, and may be flexible and elastic. The layers may be stacked or folded. Opposing kinetic force 308 and force 310 may exert energy vertically such that top mold 302 and bottom mold 306 approaches green part 304. Force 308 and force 310 may be applied mechanically, such as, e.g., by a human hand or a machine, and may cease after coming into contact and applying pressure to green part 304 such that green part 304 is deformed according to a reverse configuration of the wavy patterns embossed on an undersurface of top mold 302 and an oversurface of bottom mold 306. The mold of FIG. 3A may be used to produce a plurality of identical capacitors that is to be cut into individual pieces at a later stage, prior to being sintered. The portion shown is responsible for the production of a single, individual capacitor.

FIG. 3B shows a mold that corresponds to the production of a single, individual capacitor. Contrary to the resulting capacitors of the mold in FIG. 3A, the resulting capacitor of the mold in FIG. 3B does not require cutting into individual pieces. The mold may comprise top mold 312 positioned above green part 304, and bottom mold 316 positioned below green part 304. Green part 304 may comprise alternating layers of ceramic and conductive layers, and may be flexible and elastic. The layers may be stacked or folded. Opposing kinetic force 308 and force 310 may exert energy vertically such that top mold 302 and bottom mold 306 approaches green part 304. Force 308 and force 310 may be applied mechanically, such as, e.g., by a human hand or a machine, and may cease after coming into contact and applying pressure to green part 304 such that green part 304 is deformed according to a reverse configuration of the wavy patterns embossed on an undersurface of top mold 312 and an oversurface of bottom mold 316.

Both molds of FIG. 3A and FIG. 3B may be made of any material, such as, e.g., plastic, polymer, ceramic, sand, metal, plaster, and composites. The molds may be 3D printed, or manufactured by any other known processes.

A capacitor is an electrical device that stores energy in an electric field between a pair of closely-spaced conductors. Capacitors may be used as energy-storage devices, and may also be used to differentiate between high-frequency and low-frequency signals. Capacitance value may be defined as a measure of how much charge a capacitor can store at a certain voltage.

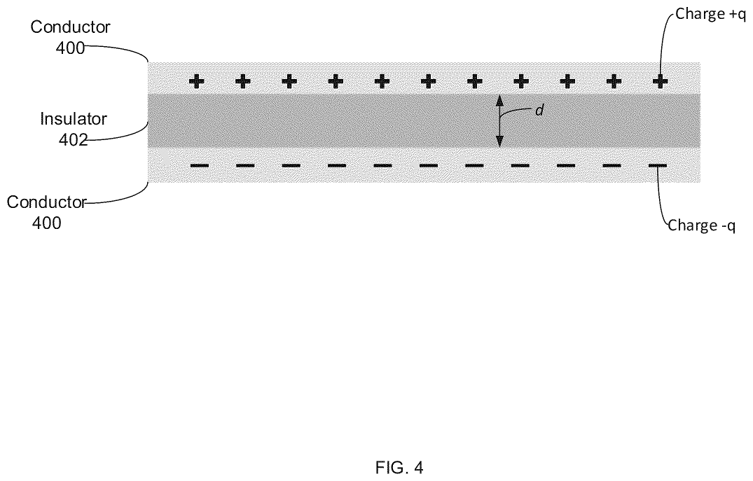

FIG. 4 is a schematic diagram of a cross-section view of an example plate capacitor. A capacitor may comprise two conductor 400, i.e., electrodes, separated by insulator 402. The plate capacitor may be manufactured from three parallel plates. If the plates have an area, A, that is separated by a distance d as shown, then the capacitance, C, can be expressed as the formula:

$$C = \frac{{κϵ}_{0} A}{d}$$

where K is the ratio of the insulator permittivity to that of a vacuum (sometimes called the dielectric constant of the material), and €₀ is the permittivity of a vacuum. The formula may be inexact due to edge effects: at the border of the parallel plates, the electric field bulges away from the capacitor. If the plate size is large relative to separation ‘d’, the edge effect is negligible.

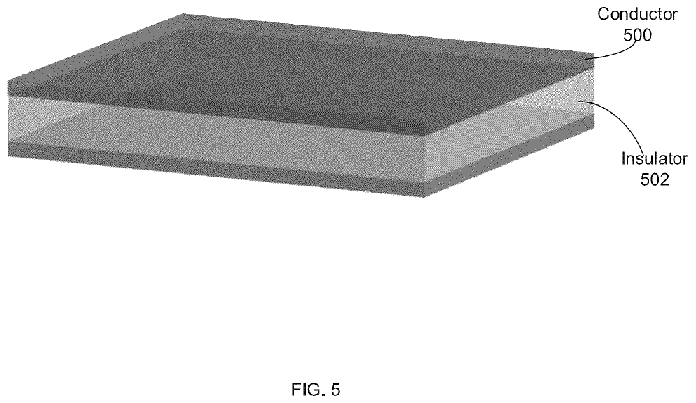

FIG. 5 is a perspective view of an example single-capacitive layer capacitor, shown semi-transparent for clarity. The typical rectangular shape may allow for ease of close-packing on a circuit board, and the height dimension may be small relative to the other dimensions to allow construction of flat or low-profile devices. A capacitor may comprise two conductors 500 separated by an insulator 502. Ceramic capacitors may be created by tape casting, in which a slurry of powdered ceramic and binder is spread over a flat surface with a knife edge to create the insulator, and coated with conductive ink.

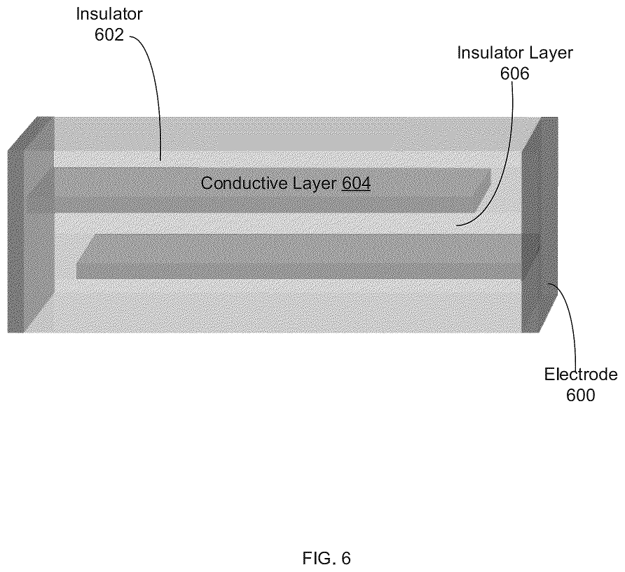

FIG. 6 shows a single capacitive layer capacitor encased in insulation, and capped with conductive electrodes. A pair of electrodes 600 may be disposed on the left side and right side of the capacitor instead of the top or bottom to permit surface mounting on a circuit board. The capacitor may be encased in insulator 602 on the top, bottom, front and back sides, e.g., the non-electrode sides, to protect the device both structurally and electrically. Note that this may entail shortening the internal conductive layer 604 where they would come too close to the opposite electrode 600, to preserve the insulative spacing to at least as great as that between layers in the vertical direction. Insulator layer 606 may be dielectric and disposed between a pair of conductive layers 604. While shown here is only a single capacitive layer for purposes of illustration, a typical MLCC may comprise multiple layers.

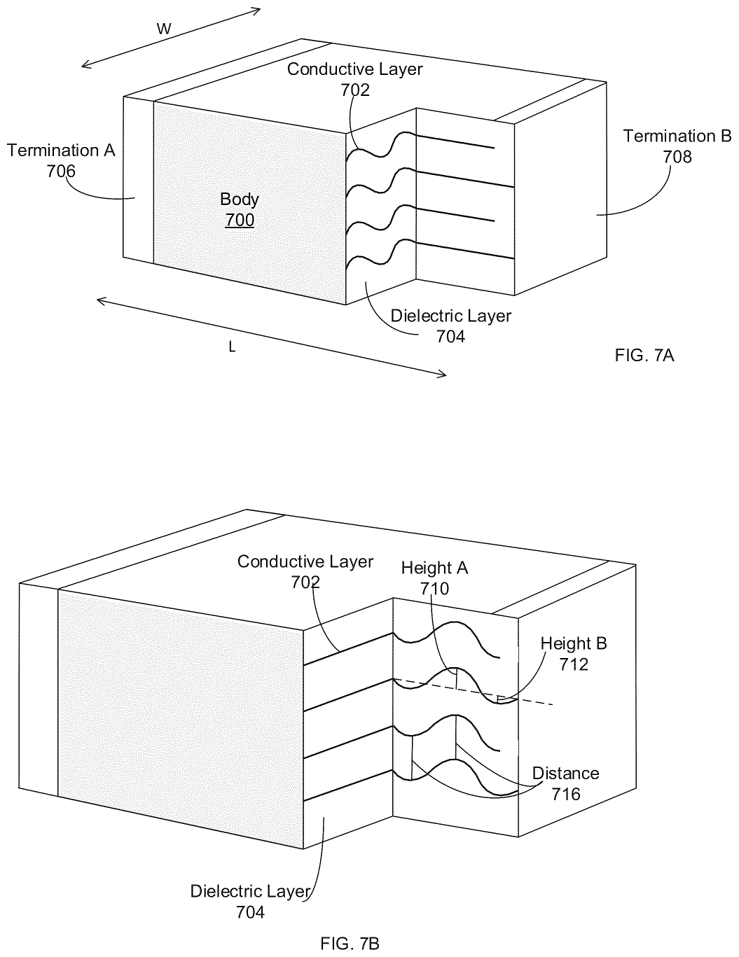

FIGS. 7A-7B show cutaway perspective views of a multilayer ceramic capacitor with wavy-shaped conductive layers. The capacitor may be in a “box” configuration wherein all 6 of its sides are flat and planar. In FIG. 7A, a multilayer ceramic capacitor (MLCC) may include a laminated body 700 comprising alternately stacked conductive layer 702 and dielectric layer 704, and a pair of external termination A 706 and termination B 708 positioned at two opposite end portions of the body 700. The conductive layer 702 may be made from a noble metal, e.g., silver, palladium, gold, platinum, and alloys thereof, or a base metal, e.g., copper and nickel. The dielectric layer 704 may be made from ceramic material comprising barium titanate. The thickness of the conductive layer 702 and/or the thickness of the dielectric layer 704 may be spatially uniform or they may vary within each layer and/or among the plurality of layers.

A plurality of conductive layer 702 may be alternately connected to termination A 706 and termination B 708, such that termination A 706 is connected to every second conductive layer 702, and termination B 708 is connected with the remaining conductive layer 702 not connected to termination A 706. When a voltage is applied to termination A 706 and termination B 708, the MLCC may produce electric fields between every two neighboring conductive layer 302 and store electric charges therein.

Conductive layer 702 may be modified from its traditional planar shape to a wave-like structure that is produced by a system or a method of the present invention. The wave shape increases surface area within a fixed volume of the capacitor, thus increasing capacitance, and may comprise smooth and repetitive oscillations without the presence of voltage-degrading sharp corners. In addition, the ends of each conductive layer 702 do not have sharp edges, such as comprising of a round corner. The one-dimensional wave pattern may run parallel to the width of the capacitor as in FIG. 7A, or it may align in parallel to the length of the capacitor as in FIG. 7B. In some embodiments, the wave pattern may be parallel to both the width and the length—in two dimensions—such that it forms an “egg-crate shape”.

FIG. 7B shows the wavy shape of conductive layer 702 aligned in parallel to the length of the capacitor body. Height A 710 of a wave's crest and height B 712 of another crest of the same wave-like structure may be uniform, or they may vary as seen in the figure. For example, height A 710 may be twice the distance or more of height B 712, but their spacing, and thus distance 716 may be unvarying. Although height A 710 and height B 712 may vary, the distance 716 between a pair of juxtaposed conductive layers 702, and thus the thickness of the dielectric layer 704, may remain constant throughout the dielectric layer 704. In addition, the thickness of the conductive layer 702 may be kept constant, but may also vary if desired. In some cases, the thickness of conductive layer 702 and/or dielectric layer 704 may vary among different respective conductive layer 702 or dielectric layer 704 of a capacitor, e.g., the thickness of each neighboring conductive layer 702 or dielectric layer 704 may alternate from a low thickness and a high thickness.

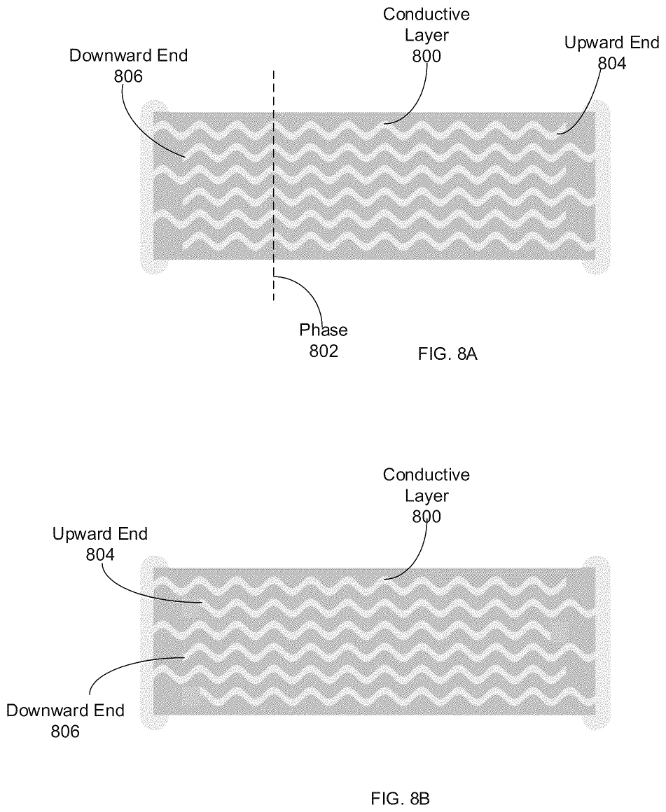

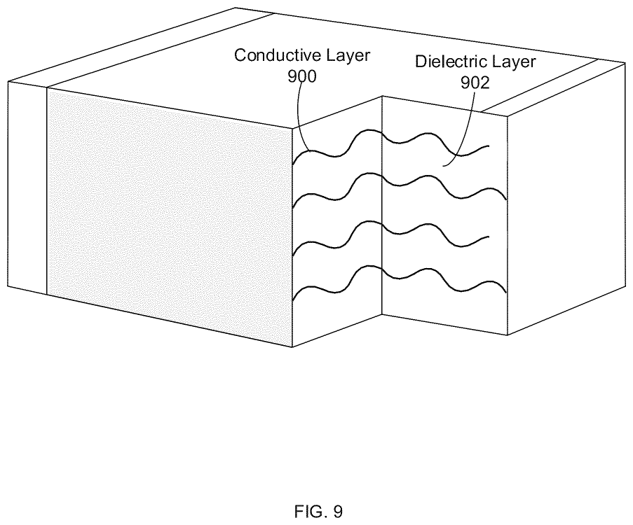

FIG. 8A is a front cross-section of multilayer ceramic capacitor modified into a wavy shape. The capacitor may be in a “box” configuration wherein all 6 of its sides are flat and planar. The capacitor shown in the figure may be stacked since the interfaces are the same sinusoidal pattern. In other words, the sinusoidal shape may comprise waves aligned in a same phase 802 in the vertical direction, for example, such that a lower wave's crest is positioned directly below an upper wave's crest, and a lower wave's trough is positioned directly below an upper wave's trough, as depicted in the figure. Aligned waves maintain a narrow range of separation between the two conductive layer 800, allowing higher voltages before there is dielectric breakdown. On the contrary, unaligned waves have varying distances between electrodes and may reduce maximum voltage; however, the invention is not so limited, and unaligned waves may be produced from the system and method presented if there is ever a desire to do so. The thickness measured in the vertical direction may be the same number of 3D volume elements, or voxels, so the volume, weight, and material cost can be identical. In some cases, the non-connecting end of each conductive layer 800 may comprise of a round shape to eliminate voltage degrading sharp corners. In addition, the non-connecting ends of each conductive layer may be configured to point upward, such as shown in upward end 804, or it may point downward, such as shown in downward end 806. Each end portion of the capacitor may comprise of upward end 804 and downward end 806 that is configured to alternate such that every second (or third and so on) conductive layer 800 end points upward with the remaining conductive layer 800 end conductive layer 702 points downward, or vice versa.

FIG. 8B shows alternating upward end and downward end of non-connecting conductive layers of an MLCC. The capacitor may be in a “box” configuration wherein all 6 of its sides are flat and planar. In addition to the alternation between upward end 804 and downward end 806 of a plurality of conductive layer 800, the lengths of the plurality of conductive layer 800 may also alternate between a full length and a length that is less the half of a wave, as seen in the figure. The precision of the system and method allows for this type of structural configuration, which may be advantageous for controlling and adjusting the specifications of the capacitor.

FIG. 9 illustrates a multilayer ceramic capacitor comprising wave-like structures aligned parallel to both of the capacitor's width and length. The capacitor may be in a “box” configuration wherein all 6 of its sides are flat and planar. The two-dimensional waves of two or more conductive layer 900 may be aligned such that a lower wave's crest is positioned directly below an upper wave's crest, and a lower wave's trough is positioned directly below an upper wave's trough. The thickness of conductive layer 900 and/or dielectric layer 902 may be constant throughout each layer, or they may vary—if desired. In some cases, the thickness of conductive layer 900 and/or dielectric layer 902 may vary among different respective conductive layer 900 or dielectric layer 902 of a capacitor, e.g., the thickness of each neighboring conductive layer 900 or dielectric layer 902 may alternate from a low thickness and a high thickness.

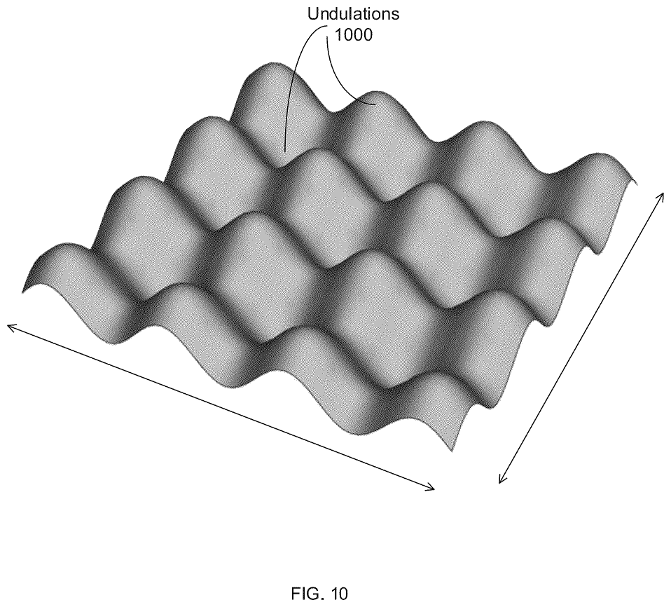

FIG. 10 is a perspective view of a conductive layer comprising an egg-crate shape. Surface area may be increased through a plurality of undulations 1000 in two dimensions without changing the amounts of conductor or insulator material. The egg crate surface may be smooth with no surface irregularities or rough, such as comprising upwards and/or downward bumps to further maximize surface area. The egg crate surface may comprise a pattern of elevations and depressions that may be evenly spaced and sized, e.g., comprising a same height and/or same base surface area. In some cases, the egg crate surface not may be evenly spaced, such as comprising an irregular pattern or a repeating pattern of spacing distances and varying elevation and depression heights. In other cases, the conductive layer may be stacked perfectly without gaps, and alternating with dielectric layers, to form an MLCC.

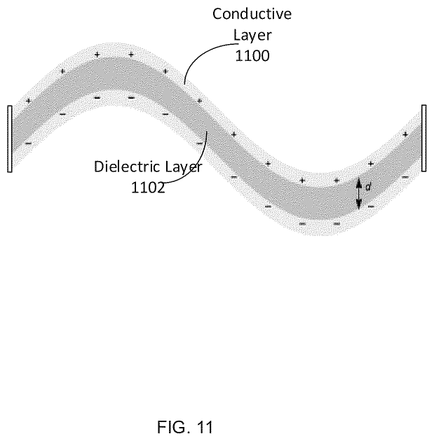

FIG. 11 is a schematic representation of a plate capacitor modified into a wave-like shape. Contrary to the box configuration, the wavy configuration may be flat and planar on 4 sides if it is sinusoidal, e.g., wavy in 1 dimension, or 2 sides if it is egg-crate shaped, e.g., wavy in 2 dimension. The terminal ends of a wavy configuration capacitor may be flat and planar. The plate capacitor (or 3-layer MLCC) may be bent into a sinusoid where the vertical depth of both conductive layer 1100 and dielectric layer 1102 is preserved. The thickness of conductive layer 1100 and/or dielectric layer 1102 may be constant throughout each layer, or they may vary—if desired. Generally, a steep curve angle of the wave may not be favorable for high voltages without dielectric breakdown due to thinning of the insulation layer. The area may be increased by over 20% for the particular wave shape in the figure, which may be the optimal shape considering electric breakdown at wider angles. The capacitance may be increased without an increase in volume, weight, or cost of materials, compared to a comparable MLCC with the traditional non-wavy cross-section. The formula may be given as:

$$C = \frac{{κϵ}_{0} A}{d}$$

However, the separation of the two conductors in the direction normal to the conductors may be less than or equal to the ‘d’ value for parallel flat plates. The insulator may be pinched to about 0.7d—or (1/√2)d—at the points of maximum upward and downward slope. This may further increase the capacitance value C, since capacitance grow inversely with separation distance.

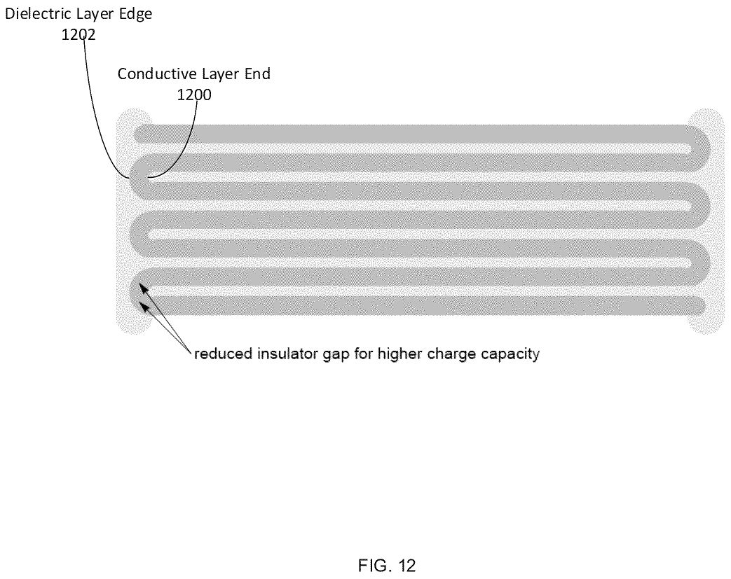

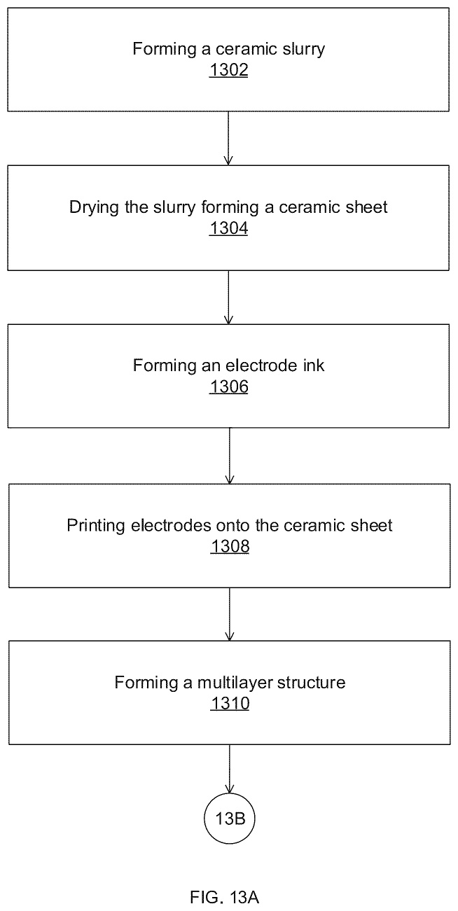

FIG. 12 illustrates a cross-section of a multilayer ceramic capacitor with rounded dielectric layer edges. Capacitor performance as a ratio to material used is highest when the electric field is as uniform as possible. If the electric field has “hot spots” as seen at a sharp corner, then the maximum operating voltage will be lower when compared with a non-sharp corner. Conversely, if the electric field has “cool spots” where there is lower intensity as seen at a non-sharp corner, the geometry may be modified as shown to raise the local field and therefore increase the ability to store electric charge (capacitance). Conductive layer end 1200 may comprise a round, bulbous, and/or wavy shape. Dielectric layer edge 1202 may comprise a concave shape that encompasses the round shape of conductive layer end 1200, such as an inverse round, bulbous, and/or wavy shape.

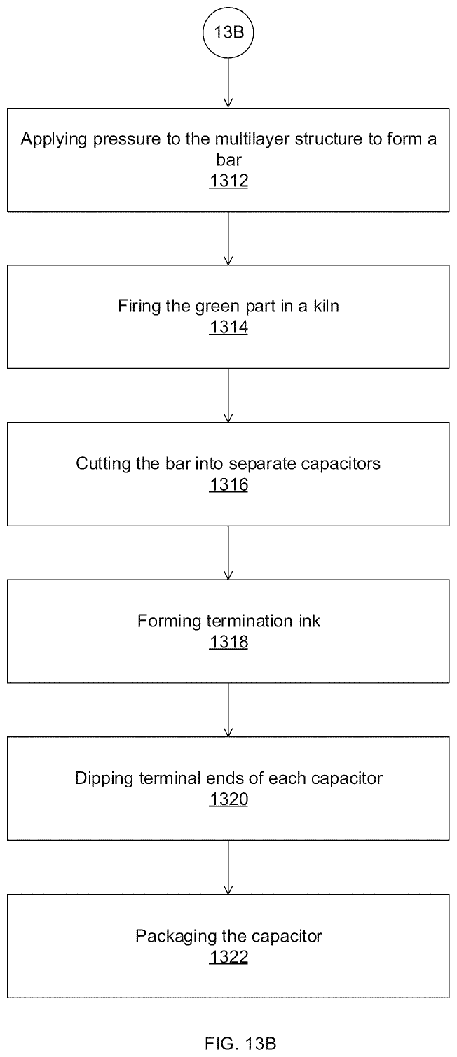

FIG. 13A-13B is a flowchart of a method for forming a wavy shape MLCC. Operation 1302 forms a ceramic slurry by mixing ceramic powder with at least one of a binder, plasticizer, dispersants, and solvent. Operation 1304 dries the ceramic slurry. For example, the slurry may be poured into a conveyor belt inside a drying oven, resulting in a dry ceramic tape. Alternatively, it may be poured onto a moving carrier film, such as, e.g., a polymer sheet, and spread into a thin, uniform layer using a doctor blade. The tape may then be cut into smaller pieces called sheets. The thickness of each sheet may determine voltage and capacitance ratings of the capacitor. Operation 1306 forms an electrode ink from a metal powder that is mixed with one or more solvents. Operation 1308 prints the electrodes onto the dry ceramic sheet using a screen printing process. Operation 1310 forms a multilayer structure, either by stacking the sheets, or alternatively folding the ceramic tape or sheets. In some cases, layers of electrodes are alternately stacked with layers of ceramic sheets to form the multilayer structure, rather than having the electrodes screen printed onto the dry ceramic sheet in operation 1308. Operation 1312 applies pressure and heat to the stack to fuse the separate layers, which may create a monolithic structure called a “bar”. A mold embossed with a reverse, or negative, of an intended form of the wavy shape may be used to press-form the bar. The wave may be 1-dimensional, such as, e.g., a sinusoid, or 2-dimensional, such as, e.g., an egg-crate shape. Operation 1314 cuts the bar into separate capacitors. The parts are now in what is called a “green state”. Generally, the smaller the size, the more parts there are in a bar.

Operation 1316 fires the green part in a kiln. In a “sacrificial” approach, the mold is created using ordinary plastics, such as those seen in low-cost 3D printers may disappear through pyrolysis as the kiln temperature increases. At the same time, the liquid in the green part may vaporize, leaving the layers rigid so they retain the wavy shape. A disadvantage to this method is that it destroys the mold and a new mold is required for every wavy capacitor, but this may be outweighed by the increase in value of the resulting capacitor. Another disadvantage is that the pyrolysis creates fumes as the plastic chars and eventually disappears, so those fumes must be properly vented and prevented from going into the atmosphere.

In a “one-stage reusable” method, the mold may be made of high-temperature ceramics that can withstand 1400° C. or more, with no degradation. Some, like the ones used as heat shields on the International Space Shuttle, can even go above 2000° C. Since these ceramic materials are not ferroelectric like barium titanate, and thus may be amenable to ceramic 3D printing techniques. In using them to shape the green part, each mold may be coated with a thin layer of material, such as, e.g., silicone oil, to prevent the green part from fusing with the ceramic mold, creating some fumes from pyrolysis/boiling but less than the sacrificial method. Another way to prevent fusion is to apply a thin layer of dust made of the high-temperature ceramic, analogous to applying flour to a rolling pin when making pastries. Then, there would be no fumes produced.

In a “two-stage reusable”, Teflon (polytetrafluoroethylene, or PTFE), which may now be 3D-printable by low-cost extrusion printers, is used to create the mold. It has a melting point of 327° C. If the molds are 3D printed in Teflon, the green part could be raised to lower temperatures (120-150° C.) and held at that temperature until its liquid component is gone and the part is rigid, i.e., cured. To prevent the green part from being brittle and weak, the ceramic slurry at the initial stages of the process may comprise a curing or thermosetting type of binder, such as, e.g., phenolformaldahyde, which may lower the setting temperature to below 300° C. The additive system may be a solvent type.

After the initial firing process, the resulting intermediate part and its molds can then be cooled to room temperature. The molds will easily be removable from the green part since Teflon is a non-stick material. The now-rigid, intermediate green part can then be put back into a kiln and run through its usual high-temperature sintering process.

Operation 1318 forms termination ink by mixing metal powder with at least one solvent. Operation 1320 dips terminal ends of each capacitor and then re-fired in a kiln to form the final part. Operation 1322 packages the MLCC to be distributed.

A number of examples have been described. Nevertheless, it will be understood that various modifications may be made without departing from the spirit and scope of the claimed invention. In addition, the logic flows depicted in the figures do not require the particular order shown, or sequential order, to achieve desirable results. Other steps may be provided, or steps may be eliminated, from the described flows, and other components may be added or removed. Accordingly, other examples are within the scope of the following claims.

What is claimed is:

1. A method, comprising:
forming a ceramic slurry;
drying the ceramic slurry,
wherein drying the ceramic slurry forms a ceramic sheet;
forming an electrode ink;
printing an electrode onto the ceramic sheet with the electrode ink;
forming at least one multilayer structure with two or more ceramic sheets comprising the electrode,
wherein the at least one multilayer structure alternates between one or more layers of ceramic and one or more layers of electrode;
applying pressure and heat to the at least one multilayer structure to fuse separate layers of the at least one multilayer structure, and
wherein applying pressure and heat to the at least one multilayer structure comprises using at least one mold to form at least one wavy-shaped capacitor.

2. The method of claim 1:
wherein the at least one mold comprises a top portion and a bottom portion, and
wherein the at least one mold is embossed with a negative of an intended form of at least one capacitor's top portion and bottom portion.

3. The method of claim 2:
wherein the at least one capacitor comprises a 1-dimensional wave.

4. The method of claim 2:
wherein the at least one capacitor comprises a 2-dimensional wave.

5. The method of claim 1, further comprising:
firing the at least one capacitor and the at least one mold assembly.

6. The method of claim 5:
wherein firing the at least one capacitor comprises using the at least one mold made from a plastic.

7. The method of claim 5:
wherein firing the at least one capacitor comprises using the at least one mold made from a high-temperature ceramic.

8. The method of claim 7:
wherein using the at least one mold made from a high-temperature ceramic comprises coating the at least one mold with a material.

9. The method of claim 8:
wherein the material is at least one of a silicone oil and dust.

10. The method of claim 5:
wherein firing the at least one capacitor comprises using the at least one mold made from polytetrafluoroethylene.

11. The method of claim 10:
wherein using the at least one mold made from polytetrafluoroethylene comprises firing at a temperature range of 120° C. to 150° C.

12. The method of claim 11, further comprising:
holding the temperature range at a predetermined amount of time to permit evaporation of liquid from the at least one capacitor.

13. The method of claim 10:
wherein using the at least one mold made from polytetrafluoroethylene comprises using a binder of thermosetting type during the formation of the ceramic slurry.

14. The method of claim 5, further comprising:
cutting the sheet into separate capacitors when 2 or more capacitors are formed from 2 or more molds.

15. The method of claim 14, further comprising:
forming termination ink.

16. The method of claim 15, further comprising:
dipping terminals of the at least one capacitor into the termination ink.

17. The method of claim 16, further comprising:
firing the at least one capacitor comprising termination ink to form a final product.

18. A method, comprising:
forming a ceramic slurry;
drying the ceramic slurry,
wherein drying the ceramic slurry forms a ceramic sheet;
forming an electrode ink;
forming an electrode sheet from the electrode ink;
forming at least one multilayer structure with two or more ceramic sheets comprising the electrode sheet,
wherein the at least one multilayer structure alternates between one or more layers of ceramic sheets and one or more layers of electrode sheets;
applying pressure and heat to the at least one multilayer structure to fuse separate layers of the at least one multilayer structure,
wherein applying pressure and heat to the at least one multilayer structure comprises using at least one mold to form at least one wavy-shaped capacitor,
wherein the at least one mold comprises a top portion and a bottom portion, and
wherein the at least one mold is embossed with a negative of an intended form of at least one capacitor's top portion and bottom portion.

19. The method of claim 2:
wherein the capacitor comprises a sinusoidal wave.

20. The method of claim 2:
wherein the capacitor comprises an egg-crate shape wave.
